(19) United States
(12) Patent Application Publication
(10) Pub. No.: US 2007/0109570 A1
(43) Pub. Date: May 17, 2007

(54) Apparatus, system and method for reproducing color according to light source

(75) Inventors: Min-ki Cho, Seoul (KR); Heui-keun Choh, Seongnam-si (KR); Se-eun Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/525,074

(22) Filed: Sep. 22, 2006

(30) Foreign Application Priority Data
Nov. 15, 2005 (KR) 10-2005-0109269

(51) Int. Cl. H04N 1/60

(52) U.S. Cl. 358/1.9; 358/504

(57) ABSTRACT

A host apparatus, system, and method are provided for reproducing color by predicting change in color of an image according to chromaticity of various observation light sources. The host apparatus includes: a lookup-table-generation module generating mapping information with regard to an image having a format and a calibrated image, which corresponds to the image and is calibrated according to an observation light source; and an image calibration module calibrating an input original image according to an observation light source selected by a user based on the mapping information.

### CROSS-REFERENCE TO RELATED APPLICATION

This application is based on and claims priority from Korean Patent Application No. 10-2005-0109269, filed on Nov. 15, 2005, the disclosure of which is incorporated herein in its entirety by reference.

### BACKGROUND OF THE INVENTION

1. Field of the Invention

Apparatuses, systems and methods consistent with the present invention relate generally to color reproduction, and more particularly to reproducing color by predicting a change in color of an image according to chromaticity of various observation light sources.

2. Description of the Related Art

A related art color-image-outputting apparatus calibrates color on the basis of one observation light source (e.g., a standard white point “D50”), so that the color-image-outputting apparatus can obtain a satisfactory result when the observation light source serves as a reference observation light source.

However, unsatisfactory related art results may occur in relation to other observation light sources.

Therefore, there is an unmet need in the related art for a method that can calibrate and reproduce color according to various observation environments.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus, system and method for reproducing an image according to various observation light sources.

According to an aspect of the present invention, there is provided a host apparatus for reproducing color according to a light source, the host apparatus including: a lookup-table-generation module generating mapping information with regard to an image having a format and a calibrated image, which corresponds to the image and is calibrated according to an observation light source; and an image calibration module calibrating an input original image according to an observation light source selected by a user based on the mapping information.

According to another aspect of the present invention, there is provided a color reproduction system including: a host apparatus providing a calibrated image by calibrating an original image based on mapping information with regard to an image having a format and a calibrated image, which corresponds to the image and is calibrated according to an observation light source; and an output apparatus outputting the calibrated image.

According to still another aspect of the present invention, there is provided a color reproduction method including: generating mapping information with regard to an image having a format and a calibrated image, which corresponds to the image and is calibrated according to an observation light source; and calibrating an input original image according to an observation light source selected by a user based on the mapping information.

### BRIEF DESCRIPTION OF THE DRAWINGS

The above and other aspects of the present invention will become apparent from the following detailed description of exemplary embodiments taken in conjunction with the accompanying drawings, in which:

FIG. 1 is a view schematically illustrating the construction of a color reproduction system according to an exemplary embodiment of the present invention;

FIG. 2 is a block diagram illustrating the construction of a host apparatus according to an exemplary embodiment of the present invention;

FIG. 3 is a flowchart illustrating the procedure for generating a first lookup table according to an exemplary embodiment of the present invention;

FIG. 4 is a view illustrating the procedure for calibrating an image according to an exemplary embodiment of the present invention;

FIG. 5 is a block diagram illustrating the construction of an output apparatus according to an exemplary embodiment of the present invention;

FIG. 6 is a flowchart illustrating the procedure for generating a second lookup table according to an exemplary embodiment of the present invention;

FIG. 7 is a view illustrating the procedure for converting an image according to an exemplary embodiment of the present invention; and

FIGS. 8A and 8B are views illustrating resultant images obtained according to an exemplary embodiment of the present invention.

### DETAILED DESCRIPTION OF THE EXEMPLARY EMBODIMENTS

Hereinafter, an exemplary embodiments will be described with reference to the accompanying drawings.

Advantages and features of the present invention and methods of achieving them will be apparent to those skilled in the art from the detailed description of the exemplary embodiments together with the accompanying drawings. The scope of the present invention is not limited to the exemplary embodiments disclosed in the specification, and the present invention can be realized in various types. The described exemplary embodiments are presented for the sake of completeness, and to enable those skilled in the art to completely understand the scope thereof, the present invention is defined only by the scope of the claims.

A host apparatus, system, and method of color reproduction according to the exemplary embodiments are described hereinafter with reference to flowchart illustrations of user interfaces, methods, and computer program products. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded into a computer or other programmable data processing apparatus to cause a series of operations to be performed on the computer or other programmable apparatus to produce a computer implemented process such that the instructions that are executed in the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). In some alternative implementations, the functions noted in the blocks may occur out of order. For example but not by way of limitation, two blocks shown in succession may in fact be executed substantially concurrently or the blocks may sometimes be executed in reverse order depending upon the functionality involved.

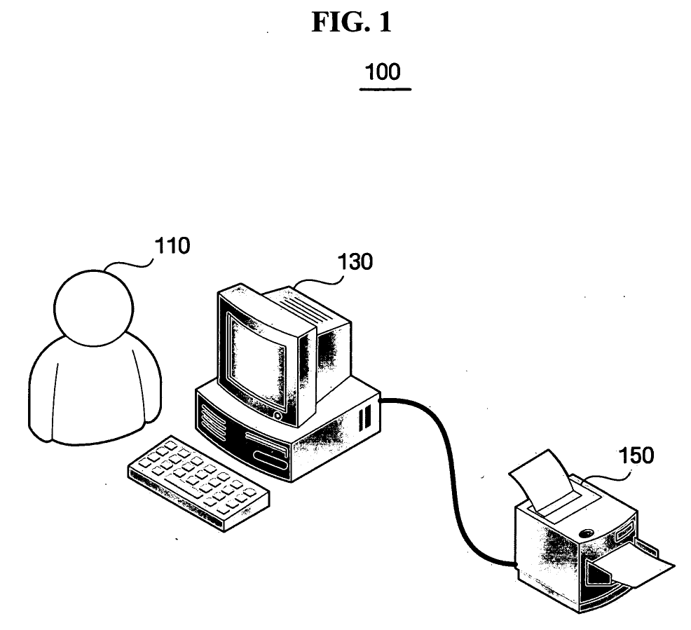

FIG. 1 is a view schematically illustrating the construction of a color reproduction system according to an exemplary embodiment of the present invention. The color reproduction system 100 according to the exemplary embodiment includes a host apparatus 130 and an output apparatus 150. The host apparatus 130 calibrates an original image according to observation light sources, so as to provide the calibrated images, and the output apparatus 150 outputs the calibrated images through an output medium such as paper (e.g., printing).

When a user 110 wants to output an image by converting a specific image (e.g., an RGB image) into an image obtained with an observation light source using the host apparatus 130, the host apparatus 130 calibrates the original RGB image into a calibrated RGB image obtained with a specific observation light source based on a lookup table.

Thereafter, the host apparatus 130 outputs the calibrated RGB image to the output apparatus 150.

The output apparatus 150 converts the calibrated RGB image into an image for output, based on a lookup table, to provide the user with an image in which a specific light source is reflected.

While the system 100 of FIG. 1 shows the host apparatus 130 and the output apparatus 150 connected to each other through a wired medium, the host apparatus 130 and the output apparatus 150 may be coupled through a wireless medium, or any other communication scheme as would be understood by one skilled in the art.

While the system 100 of FIG. 1 shows the case in which the host apparatus 130 and the output apparatus 150 are separately constructed, modules acting as the host apparatus and output apparatus may be integrally connected in one system so as to construct the color reproduction system 100.

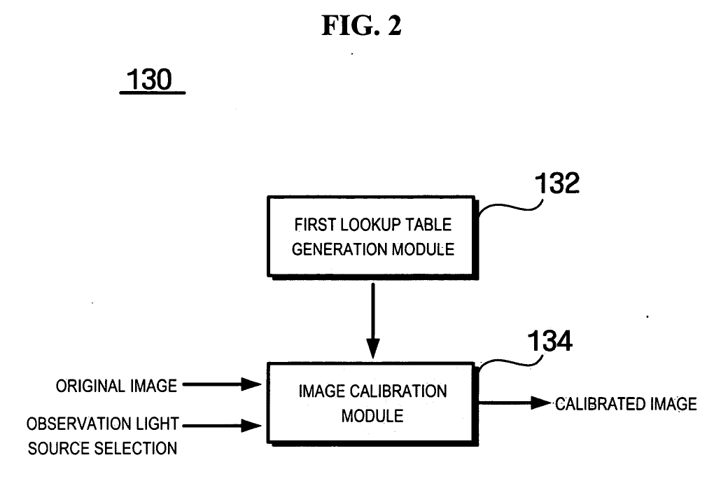

FIG. 2 is a block diagram illustrating the construction of the host apparatus according to an exemplary embodiment of the present invention. The host apparatus 130 includes a first lookup-table-generation module 132 and an image calibration module 134.

The term “module”, as used herein, includes, but is not limited to, a software or hardware component, such as a Field Programmable Gate Array (FPGA) or an Application Specific Integrated Circuit (ASIC), which performs certain tasks. A module may be configured to reside on the addressable storage medium and configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. However, the exemplary embodiment is not limited thereto.

First, the first lookup-table-generation module 132 generates mapping information with regard to an image (e.g., an RGB image) having a format and calibrated images of the above image, which have been calibrated according to various observation light sources, and stores the mapping information in the form of a lookup table.

Thereafter, when an original image is input into the image calibration module 134 according to selection of the user 110 or according to a process of the host apparatus 130, the image calibration module 134 can obtain information about a calibrated image, which corresponds to the original image and is obtained with the observation light source selected by the user 110, from the lookup table generated by the first lookup-table-generation module 132.

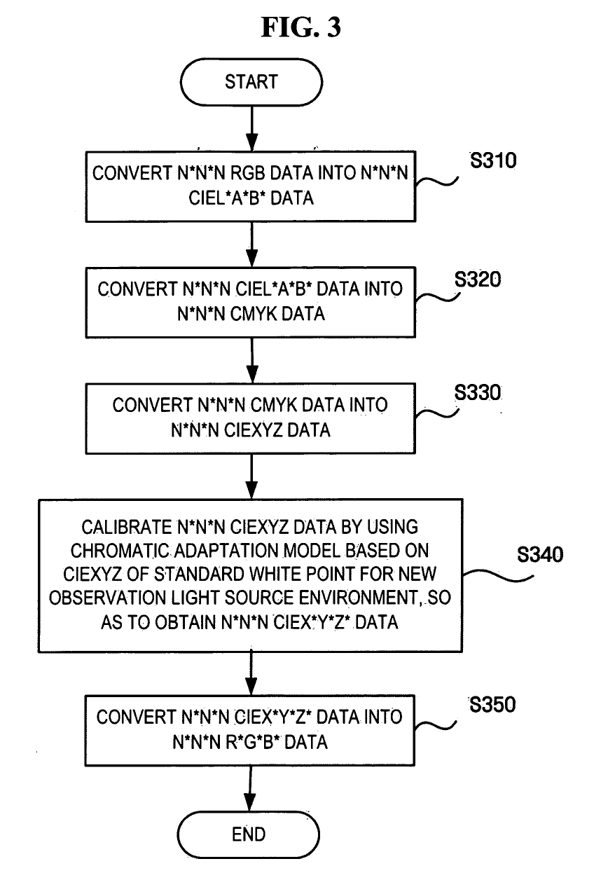

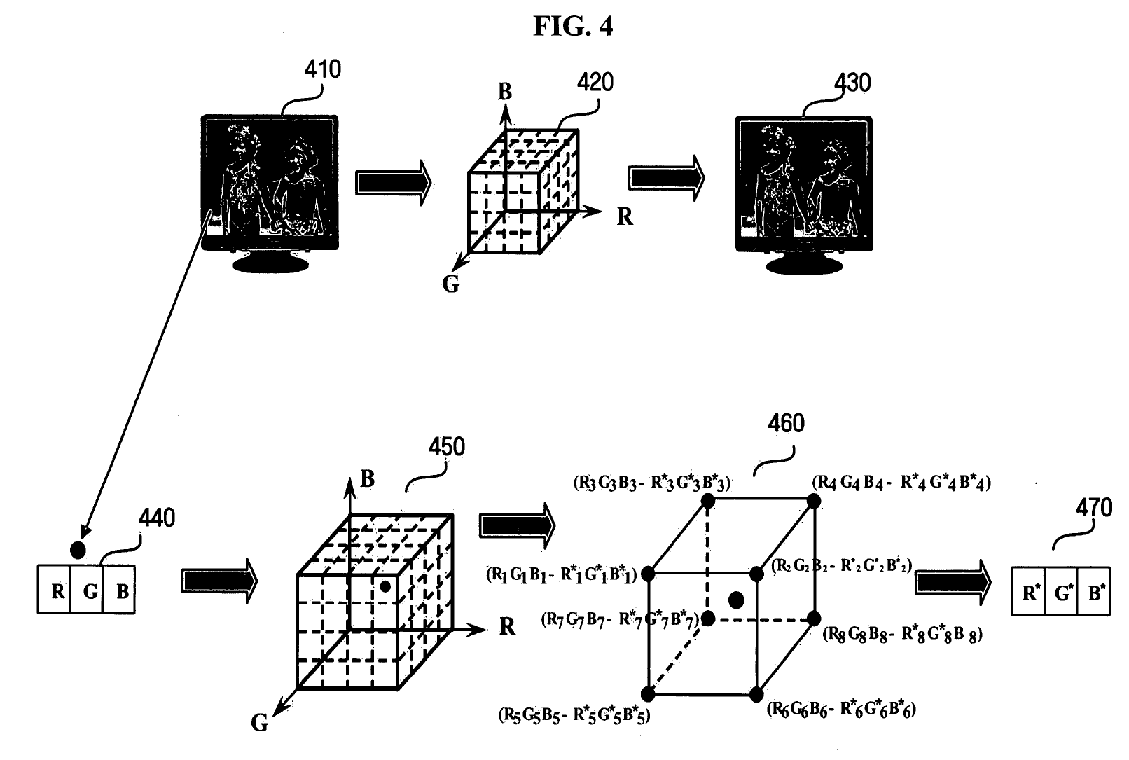

FIG. 3 is a flowchart illustrating the procedure for generating a lookup table in the first lookup-table-generation module 132, and FIG. 4 is a view illustrating the procedure for calibrating an input original image based on the generated lookup table in the image calibration module 134, which will now be described in detail.

First, the first lookup-table-generation module 132 converts NxNxN RGB data into NxNxN CIEL*a*b* data by using an ICC (International Color Consortium) profile for the display of the host apparatus 130 (operation S310). The ICC was established in 1993 for the purpose of constructing a color management system which can obtain the substantially same quality of color images from all hardware, regardless of the manufacturers of computers and peripheral devices, and for the purpose of establishing a standard for device profiles. An ICC profile stores color information required for color match between different devices. More detailed information for the ICC profile can be found in www.color.org.

The ICC profile is a data file representing the color representation characteristic of a corresponding device, and may be regarded as a data file which is required for inputting/outputting matching colors into/from each computer for the purpose of color management, regardless of the properties of input/output devices or graphic programs.

For example but not by way of limitation, when a displayer supports an RGB image and a printer supports a CMYK (Cyan, Magenta, Yellow, and Black) image, an RGB image can be converted into a CMYK image through the CIEL*a*b* of the ICC profile.

In addition, a basic color space for color conversion using an ICC profile is called a profile connection space (PCS), and, for example, may include color spaces, such as CIEL*a*b* and CIEXYZ.

The first lookup-table-generation module 132 converts the NxNxN CIEL*a*b* data into NxNxN CMYK data by using an ICC profile for the output apparatus 150 (operation S320), and then converts the NxNxN CMYK data into NxNxN CIEXYZ data by using the ICC profile for the output apparatus 150 (operation S330).

Then, the first lookup-table-generation module 132 calibrates the NxNxN CIEXYZ data obtained in operation S330, by using a chromatic adaptation model based on CIEXYZ of a standard white point in new observation light source environment (e.g., A light, D50 light, or D65 light) (operation S340).

In this case, a chromatic adaptation phenomenon refers to a property of the human visual system, which sees physically different colors as an identical color by adapting his/her eyes to surrounding light according to surrounding illuminators. If color “C2” seen by the user under an illumination is identical to the color ‘C1’ seen by the user under an illumination, color “C2” is called a “corresponding color” of the color “C1”. Further, chromatic adaptation models for predicting such corresponding colors under different illuminators have been proposed. Currently-proposed chromatic adaptation models include the von Kries linear model, the MacAdam model, the Nayatani model, the Bartleson model, and the Fairchild model.

For example, according to the von Kries linear model, when a CIEXYZ value under an original observation light source condition (e.g., under the D50) is “X₁, Y₁, Z₁” and a CIEXYZ value under a new observation light source condition (e.g. under the D65) is “X₂, Y₂, Z₂”, the relation between the “X₁, Y₁, Z₁” and the “X₂, Y₂, Z₂” can be expressed by equation 1:

$$[ \begin{matrix}\begin{matrix}{X}_{2} \\ {Y}_{2}\end{matrix} \\ {Z}_{2}\end{matrix} ] = {M}^{- 1} [ \begin{matrix}{L}_{white 2} / {L}_{white 1} & 0 & 0 \\ 0 & {M}_{white 2} / {M}_{white 1} & 0 \\ 0 & 0 & {S}_{white 2} / {S}_{white 1}\end{matrix} ] M [ \begin{matrix}\begin{matrix}{X}_{1} \\ {Y}_{1}\end{matrix} \\ {Z}_{1}\end{matrix} ]$$

Herein, in the von Kries linear model, matrix “M” represents a conversion matrix from a CIEXYZ to an LMS, which is a relative response value in a cone. Such a matrix “M” is expressed as equation 2.

$$M = [ \begin{matrix}0.4002 & 0.7076 & - 0.0808 \\ - 0.2263 & 1.1653 & 0.0457 \\ 0.0000 & 0.0000 & 0.9182\end{matrix} ] \qquad Equation 2$$

In addition, terms “L_{white1}”, M_{white1}”, and “S_{white1}” represent an LMS response of the standard white point under the original observation light source condition (e.g., D50), and terms “L_{white2}”, “M_{white2}”, and “S_{white2}” represent LMS responses of the standard white point under the new observation light source condition (e.g., D65), in which the “L”, “M”, and “S” represent the tri-receptor of an eye, that makes different spectral responses.

Also, the original observation light source condition represents an observation light source condition basically-established in the host apparatus 130.

After operation S340, the first lookup-table-generation module 132 converts the NxNxN CIEXYZ coordinate data, which have been calibrated in operation S340, into NxNxN R′G′B′ data (operation S350), thereby completing a lookup table which stores the NxNxN R′G′B′ data corresponding to the NxNxN RGB data with respect to an observation light source.

The RGB coordinate system and CMYK coordinate system are dependent on devices, while the CIEXYZ coordinate system and CIEL*a*b* coordinate system are independent of devices.

FIG. 4 is a view illustrating the procedure for calibrating an original image in the image calibration module 134 according to an exemplary embodiment of the present invention. Reference numeral 410 represents an original RGB image, reference numeral 420 represents a lookup table generated by the first lookup-table-generation module 132, and reference numeral 430 represents an RGB image calibrated by the image calibration module 134.

The lookup table 420 is used to calibrate an image based on NxNxN observation light sources, and stores mapping information with regard to original RGB images and R′G′B′ images corresponding to the original RGB images.

Referring to FIG. 4, reference numeral 440 represents an RGB pixel contained in the original RGB image, and data of the RGB pixel are searched for and extracted from a sub-lookup table (sub-LUT) including the RGB pixel data (see reference numeral 450).

Thereafter, calibrated RGB pixel data are obtained from the RGB pixel data and the extracted sub-lookup table by an interpolation method. In this case, a tri-linear interpolation method, a tetrahedral interpolation method, a PRISM interpolation method, a pyramid interpolation method, etc. may be used, but the exemplary embodiment is not limited thereto.

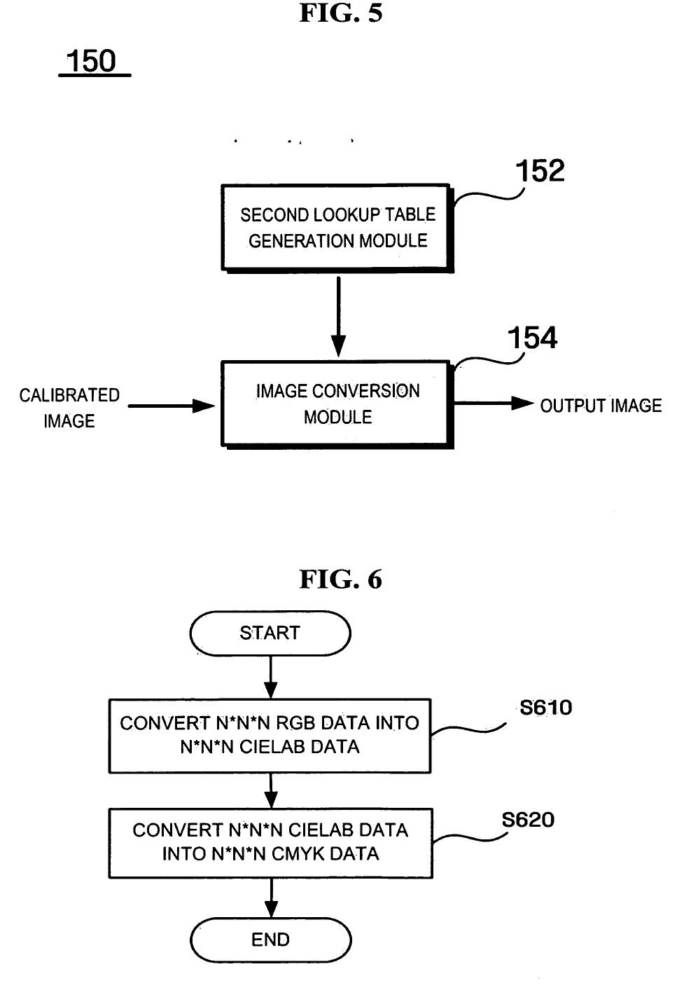

FIG. 5 is a block diagram illustrating the construction of an output apparatus according to an exemplary embodiment of the present invention. The output apparatus 150 according to the exemplary embodiment includes a second lookup-table-generation module 152 and an image conversion module 154.

First, the second lookup-table-generation module 152 generates mapping information with regard to an image (e.g., an RGB image) having a format and an output image corresponding to the above image, and stores the mapping information in the form of a lookup table.

Thereafter, when receiving an image, which is based on an observation light source provided by the image calibration module 134 of the host apparatus 130, the image conversion module 154 can obtain an output image corresponding to the received image from the lookup table generated by the second lookup-table-generation module 152.

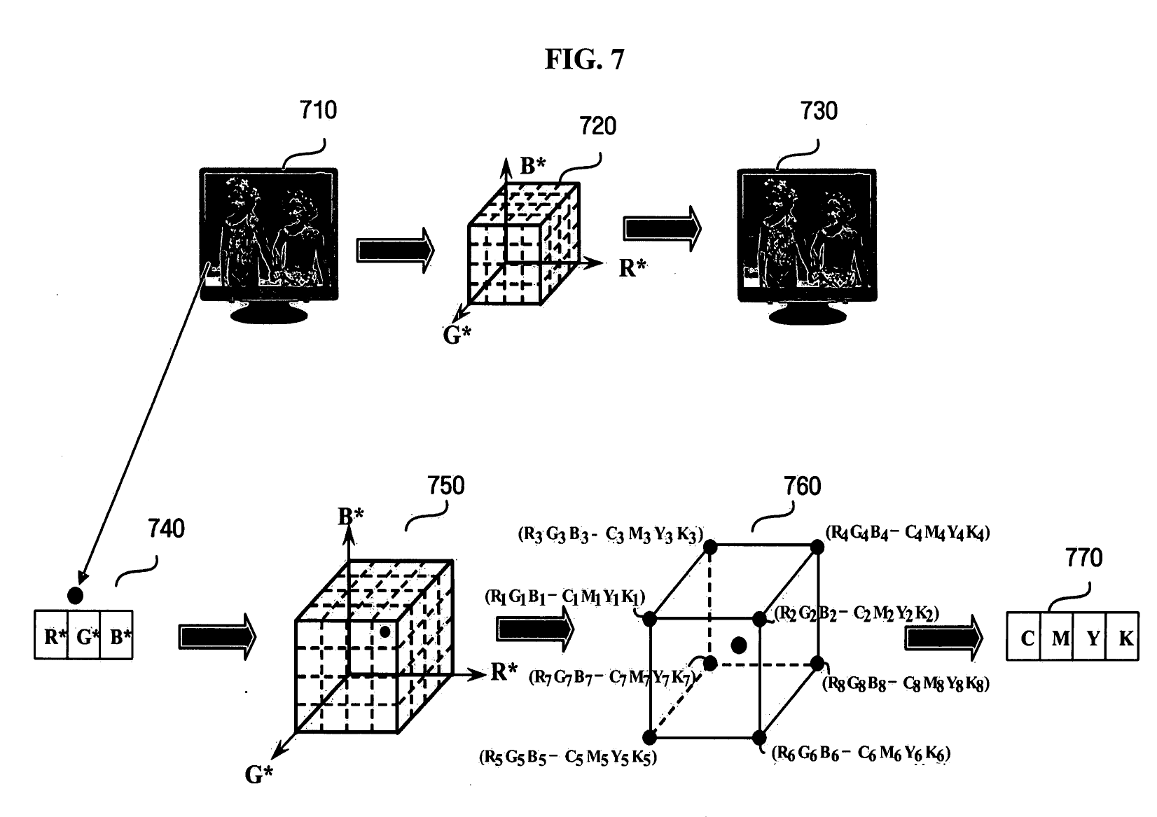

FIG. 6 is a flowchart illustrating the procedure for generating a lookup table in the second lookup-table-generation module 152, and FIG. 7 is a view illustrating the procedure for outputting an input image from the image conversion module 154 based on the generated lookup table.

First, the second lookup-table-generation module 152 converts NxNxN RGB data, which have been calibrated by the image calibration module 134, into NxNxN CIEL*a*b* coordinate data, by using an ICC profile for the display of the host apparatus 130 (operation S610).

Thereafter, the second lookup-table-generation module 152 converts the NxNxN CIEL*a*b* coordinate data into NxNxN CMYK coordinate data by using an ICC profile for the output apparatus 150 (operation S620).

FIG. 7 is a view illustrating the procedure for outputting an image calibrated by the image calibration module 134 according to an exemplary embodiment. Reference numeral 710 represents an RGB image calibrated by the image calibration module 134, reference numeral 720 represents a lookup table generated by the second lookup-table-generation module 152, and reference numeral 730 represents a CMYK image for output, which is obtained through the converting operation of the image conversion module 154.

In addition, reference numeral 740 represents an RGB pixel contained in the RGB image calibrated by the image calibration module 134, and the image conversion module 154 searches for and extracts data of the RGB pixel from a sub-lookup table (sub-LUT) including the RGB pixel data (see reference number 750).

Thereafter, CMYK data for output are calculated and obtained from the RGB pixel data and the extracted sub-lookup table by an interpolation method. In this case, a tri-linear interpolation method, a tetrahedral interpolation method, a PRISM interpolation method, a pyramid interpolation method, etc. may be used.

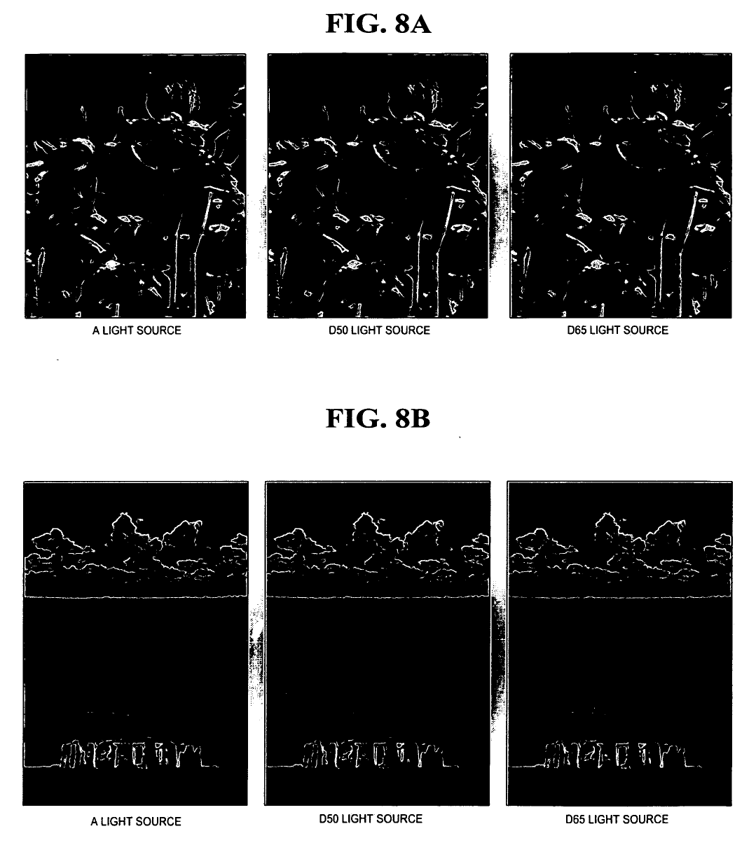

FIGS. 8A and 8B are views illustrating resultant images obtained according to an exemplary embodiment, in which it can be understood that different images are obtained depending on light sources, that is, depending on an A light source, a D50 light source, and a D65 light source.

As described above, the present invention has the effect of reproducing images, which can be changed depending on various observation light sources.

Although exemplary embodiments have been described for illustrative purposes, those skilled in the art will appreciate that various modifications, additions and substitutions are possible, without departing from the essential features and the scope and spirit of the invention as disclosed in the accompanying claims. Therefore, it should be appreciated that the exemplary embodiments described above are not limitative, but only illustrative.

What is claimed is:

1. A host apparatus that reproduces color according to a light source, the host apparatus comprising:
a lookup-table-generation module which generates mapping information with regard to an image having a format and a calibrated image, which corresponds to the image and is calibrated according to an observation light source; and
an image calibration module which calibrates an input original image according to a selected observation light source based on the mapping information.

2. The host apparatus of claim 1, wherein the lookup-table-generation module generates the mapping information using an International Color Consortium profile.

3. The host apparatus of claim 1, wherein the lookup-table-generation module generates the mapping information using a chromatic adaptation model based on a color space of a standard white point in a new observation light source environment.

4. The host apparatus of claim 3, wherein the color space comprises a CIEXYZ color space.

5. A color reproduction system comprising:
a host apparatus which provides a calibrated image by calibrating an original image based on mapping information with regard to an image having a format and a calibrated image, which corresponds to the image and is calibrated according to an observation light source; and
an output apparatus which outputs the calibrated image.

6. The system of claim 5, wherein the mapping information is generated using an International Color Consortium profile.

7. The system of claim 5, wherein the mapping information is generated via a chromatic adaptation model based on a color space of a standard white point in a new observation light source environment.

8. The system of claim 7, wherein the color space comprises a CIEXYZ color space.

9. A color reproduction method comprising:
generating mapping information with regard to an image having a format and a calibrated image, which corresponds to the image and is calibrated according to an observation light source; and
calibrating an input original image according to an observation light source selected based on the mapping information.

10. The method of claim 9, wherein the mapping information is generated using an International Color Consortium profile.

11. The method of claim 9, wherein the mapping information is generated using a chromatic adaptation model based on a color space of a standard white point in a new observation light source environment.

12. The method of claim 11, wherein the color space comprises a CIEXYZ color space.

13. The method of claim 9, further comprising outputting the calibrated image.

14. The method of claim 9, wherein the outputting comprises:
converting NxNxN RGB data into NxNxN CIEL*a*b* coordinate data using an International Color Consortium profile for display of a host apparatus;
converting the NxNxN CIEL*a*b* coordinate data into NxNxN CMYK coordinate data using an ICC profile for display of an output apparatus;
converting the NxNxN CMYK coordinate data into NxNxN CIEXYZ coordinate data using an ICC profile for display of the output apparatus;
calibrating the NxNxN CIEXYZ coordinate data using a chromatic adaptation model based on a CIEXYZ of a standard white point in a new observation light source environment;
converting the calibrated NxNxN CIEXYZ coordinate data into RGB data; and generating a lookup table which stores mapping information according to the new observation light source environment.

15. A computer-readable medium containing instructions for a method of color reproduction, the method comprising:
generating mapping information with regard to an image having a format and a calibrated image, which corresponds to the image and is calibrated according to an observation light source; and
calibrating an input original image according to an observation light source selected based on the mapping information.

16. The computer readable medium of claim 15, wherein the mapping information is generated by an International Color Consortium profile.

17. The computer readable medium of claim 15, wherein the mapping information is generated by a chromatic adaptation model based on a color space of a standard white point in a new observation light source environment.

18. The computer readable medium of claim 17, wherein the color space comprises a CIEXYZ color space.

19. The computer readable medium of claim 15, further comprising outputting the calibrated image.

20. The computer readable medium of claim 15, wherein the outputting comprises:
converting NxNxN RGB data into NxNxN CIEL*a*b* coordinate data by an ICC profile for display of a host apparatus;
converting the NxNxN CIEL*a*b* coordinate data into NxNxN CMYK coordinate data by an International Color Consortium profile for display of an output apparatus;
converting the NxNxN CMYK coordinate data into NxNxN CIEXYZ coordinate data by an ICC profile for display of the output apparatus;
calibrating the NxNxN CIEXYZ coordinate data by a chromatic adaptation model based on a CIEXYZ of a standard white point in a new observation light source environment;
converting the calibrated NxNxN CIEXYZ coordinate data into RGB data; and
generating a lookup table that stores mapping information according to the new observation light source environment
